(19) United States
(12) Patent Application Publication
(10) Pub. No.: US 2016/0278363 A1
(43) Pub. Date: Sep. 29, 2016

(54) GLUE MOUSETRAP STRUCTURE WITH A WARNING FUNCTION

(71) Applicant: Hao-Jung HSU, Taipei City (TW)

(72) Inventor: Hao-Jung HSU, Taipei City (TW)

(21) Appl. No.: 14/672,152

(22) Filed: Mar. 28, 2015

(51) Int. Cl. A01M 23/00; G08B 5/36; G08B 21/24

(52) U.S. Cl. CPC A01M 23/005; G08B 21/24; G08B 5/36

(57) ABSTRACT

A glue mousetrap structure with a warning function including primarily a baseboard and a carrier arranged on top of the baseboard. A support body is arranged at a center between the baseboard and the carrier to allow the carrier to sway full-directionally. On a periphery of the carrier is arranged a plurality of sensing members that are connected to a control circuit provided with display lamps. When in use, a glue mousetrap board is placed on the carrier which is then placed on a ceiling or in an appropriate place. When a mouse steps on the glue mousetrap board, the carrier will sway under the weight and trigger the plurality of sensing members. The display lamps are thereby turned on to perform a warning function to remind a user to promptly dispose of the captured mouse and prevent mouse carcass from giving off stench and having a bad impact on environmental hygiene after being left unattended for a long time.

### BACKGROUND OF THE INVENTION

1. Field of the Invention

The present invention relates to a glue mousetrap structure with a warning function, and particularly to a glue mousetrap structure with a warning function that can alert a user to the capture of a mouse so that the user may dispose of the trapped mouse promptly to prevent mouse carcass from giving off stench and having a bad impact on environmental hygiene after being left unattended for a long time.

2. Description of Related Art

For ages, mice co-exist with humans. They hide in human dwellings, steal food from humans, and spread such contagious diseases as plague. Therefore, they are universally regarded as harmful to human life and safety, and people would try all means to drive mice away from common dwellings and more particularly restaurants and grains stores. Bucket mousetraps or glue mousetraps are conventional ways of capturing mice. A glue mousetrap is usually placed on a ceiling or in an appropriate place in waiting for a mouse to step thereon and be trapped in the sticky glue. The problem is, if a user does not check the glue mousetrap in time or simply forget about it, the trapped mouse would die and its unattended carcass would give off stench and leave a bad impact on environmental hygiene. In view of this, after laborious research and experiments, the applicant has devised an improved glue mousetrap structure with a warning function to remind a user to promptly dispose of a captured mouse.

### SUMMARY OF THE INVENTION

It is a primary purpose of the present invention to provide a glue mousetrap structure with a warning function that can remind a user to promptly dispose of a captured mouse in order to prevent mouse carcass from giving off stench and having a bad impact on environmental hygiene after being left unattended for a long time.

The foregoing glue mousetrap structure with a warning function includes a baseboard and a carrier arranged on top of the baseboard. A support body is arranged at a center between the baseboard and the carrier to allow the carrier to sway full-directionally. On a periphery of the carrier is arranged a plurality of sensing members that are connected to a control circuit provided with display lamps. When in use, a glue mousetrap board is placed on the carrier which is then placed on a ceiling or in an appropriate place. When a mouse steps on the glue mousetrap board, the carrier will sway under the weight and trigger the plurality of sensing members. The display lamps are thereby turned on to perform a warning function to remind a user to promptly dispose of the captured mouse and prevent mouse carcass from giving off stench and having a bad impact on environmental hygiene after being left unattended for a long time.

In the foregoing glue mousetrap structure with a warning function, the control circuit is disposed in a case body and the plurality of sensing members that are disposed on a periphery between the baseboard and the carrier are connected to the control circuit via a conducting wire. When the glue mousetrap structure is placed on a ceiling, the conducting wire will allow the case body to hang down into a user's view.

### BRIEF DESCRIPTION OF THE DRAWINGS

FIG. 1 is a three-dimensional exploded view of the present invention;

FIG. 2 is a three-dimensional view of a snap fit structure of the present invention;

FIG. 3 is a cross-section view of the present invention;

FIG. 4 is a block diagram of a control circuit in a preferred embodiment of the present invention; and

FIG. 5 is a view of the present invention in use.

### DETAILED DESCRIPTION OF THE PREFERRED EMBODIMENTS

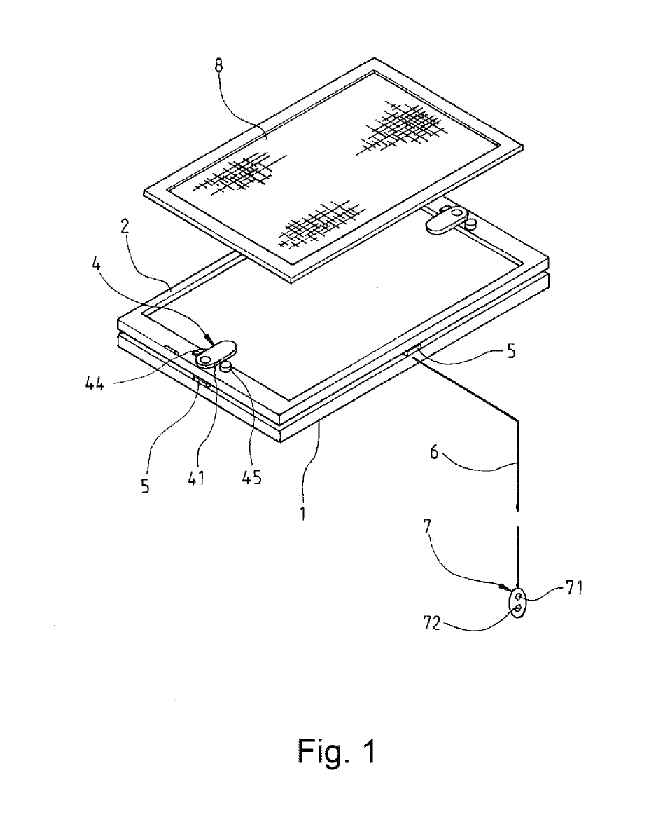

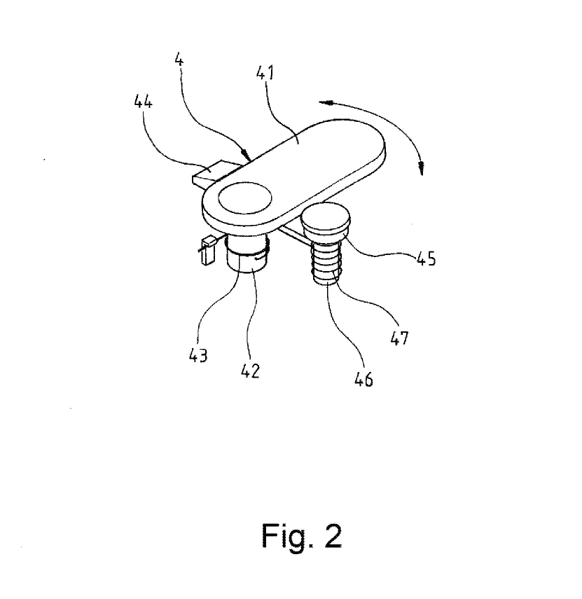

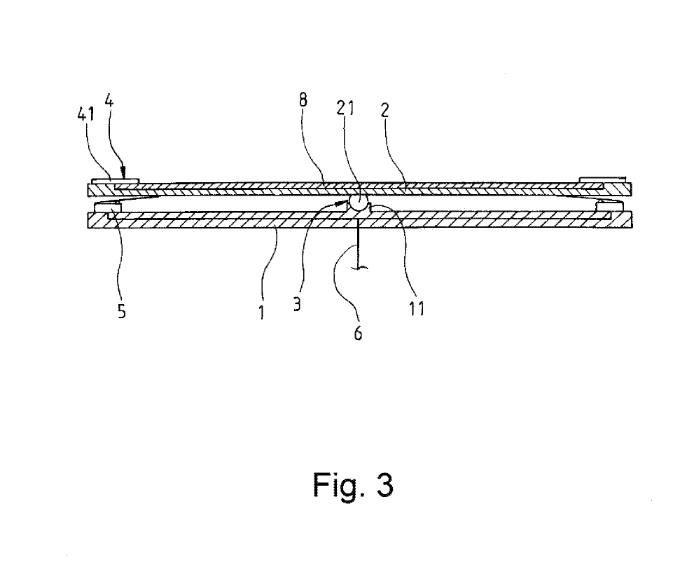

Please refer to both FIG. 1 and FIG. 2 along with FIG. 3, which show respectively a three-dimensional exploded view, a three-dimensional view of a snap fit structure, and a cross-section view according to the present invention. As these figures show, the present invention includes a baseboard 1 and a carrier 2 disposed on top of the baseboard 1, wherein a support body 3 is disposed at a center between the baseboard 1 and the carrier 2. In the present embodiment, the support body 3 includes a sphere 21 disposed on the carrier 2 and a socket 11 disposed on the baseboard 1. After being embedded in the socket 11, the sphere 21 may turn along socket 11 to allow the carrier 2 to sway full-directionally. On two sides of the carrier 2 is respectively disposed a snap fit structure 4 provided with a stopper 41. An axial part 42 is provided below the stopper 41. A torsion spring 43 is wound around the axial part 42 to keep the stopper 41 at a position parallel to a side edge of the carrier 2. On a side of the stopper 41 is disposed an inclined block 44 and a press button 45 connected to the block 44. An axial part 46 is provided at a bottom edge of the press button 45. A spring 47 is wound around the axial part 46. When the stopper 41 turns 90 degrees and passes the block 44 (the block 44 is inclined to facilitate the stopper 41 to pass it), a stopping function is provided by the block 44. When the press button 45 is pressed down, the block 44 will be disengaged from the stopper 41 and the stopper 41 will return to its original position due to the elasticity of the torsion spring 43.

A plurality of sensing members 5 are disposed on a periphery between the baseboard 1 and the carrier 2. The plurality of sensing members 5 are connected via a conducting wire 6 to a control circuit 7 that is provided with display lamps 71 and 72 (LED) and is placed in a case body. In the present embodiment, the plurality of sensing members 5 are micro-switches, mercury switches, or other touch switches.

A glue mousetrap structure with a warning function is formed via a combination of the foregoing components. After the glue mousetrap board 8 is placed on the carrier 2, the stoppers 41 on two sides of the carrier 2 are turned 90 degrees to be snap-fitted to the glue mousetrap board 8. The glue mousetrap board 8 is placed on a ceiling or in an appropriate place. When a mouse steps on the glue mousetrap board 8, the carrier 2 will sway under the weight and trigger the plurality of sensing members 5. The display lamps 71 and 72 are thereby turned on to perform a warning function to remind a user to promptly dispose of the captured mouse a prevent mouse carcass from giving off stench and having a bad impact on environmental hygiene after being left unattended for a long time.

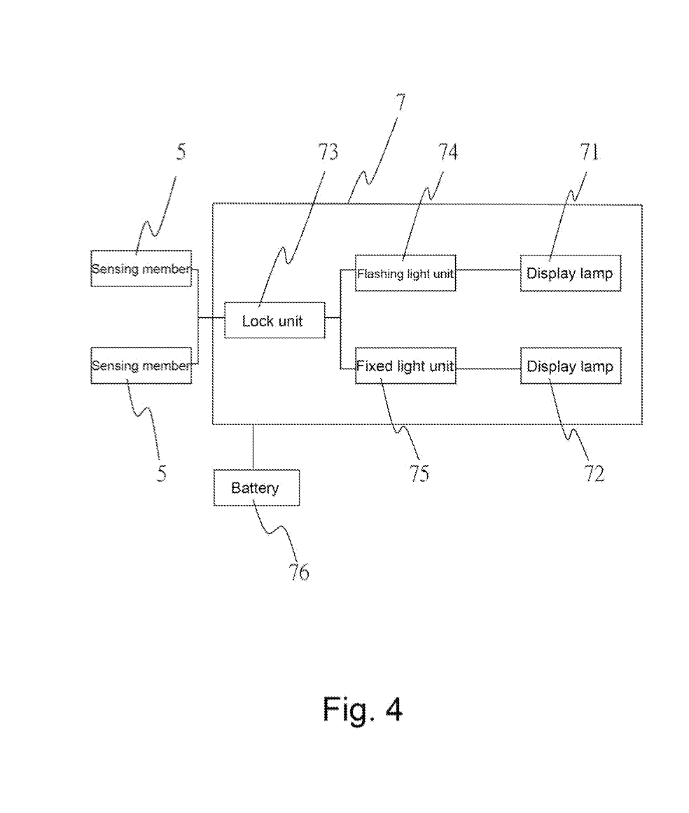

Please refer to FIG. 4. A block diagram of a control circuit in a preferred embodiment of the present invention is shown. As the figure shows, the control circuit 7 of the present invention includes a control unit 73, a flashing light unit 74 connected to the control unit 73, and a fixed light unit 75. The display lamps 71 and 72 are respectively connected to the flashing light unit 74 and the fixed light unit 75. When any of the plurality of sensing members 5 is triggered, the control unit 73 will turn on the display lamp 71 which will start to flash. After the display lamp 71 flashes for a period of time, the control unit 73 will turn on the display lamp 72 which will be kept on to perform a warning function. The control circuit 7 is powered by a battery 76.

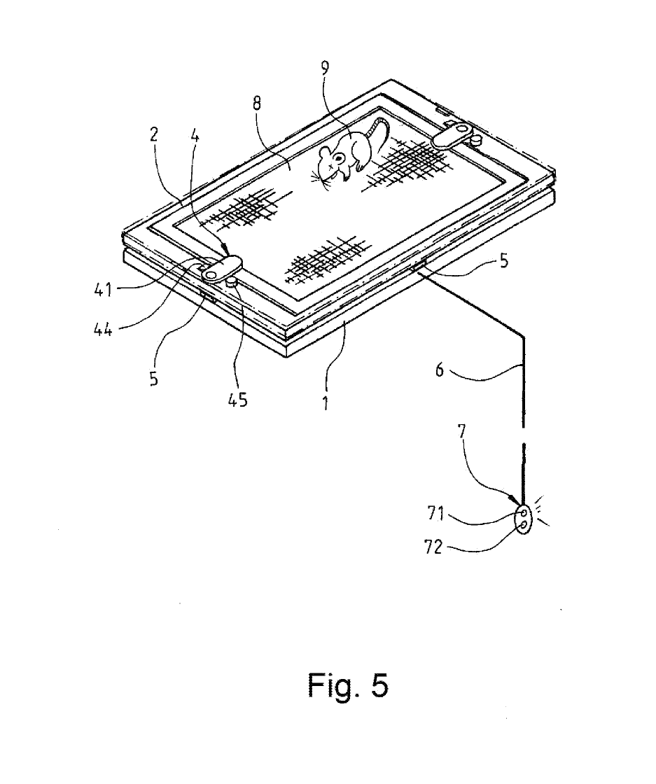

Please refer to FIG. 5. A view of the present invention in use is shown. Refer also to FIG. 3. As these figures show, when the present invention is in use, the glue mousetrap board 8 is first placed on the carrier 2. Next the stoppers 41 on two sides of the carrier 2 are turned 90 degrees to be snap-fitted to the glue mousetrap board 8. The glue mousetrap board 8 is then placed on a ceiling or in an appropriate place. When a mouse steps on the glue mousetrap board 8, the carrier 2 will sway under the weight and trigger the plurality of sensing members 5. The display lamps 71 and 72 are thereby turned on by the control circuit 7 to perform a warning function of reminding a user to promptly dispose of the captured mouse and prevent mouse carcass from giving off stench and having a bad impact on environmental hygiene after being left unattended for a long time. If a user dares not approach the glue mousetrap board 8, the following steps may be taken: the glue mousetrap structure may be pulled close to the user via the conducting wire 6, the press button 45 may be pressed down by means of a tool (e.g. a tong) to disengage the block 44 from the stopper 41, the stopper 41 will then return to its original position, and the glue mousetrap board 8 with mouse carcass thereon may be disposed of.

The foregoing preferred embodiment is illustrated of the present invention rather than limiting of the present invention. It is intended to cover various modifications and changes included within the spirit and scope of the appended claims, the scope of which should be accorded the broadest interpretation so as to encompass all such modifications and similar structures.

In view of the foregoing considerations, the present invention relates to glue mousetrap structure with a warning function including a carrier and a baseboard that are pivotally connected to each other, along with a plurality of sensing members disposed between the carrier and the baseboard to remind a user to promptly dispose of a captured mouse on the glue mousetrap board and prevent mouse carcass from giving off stench and having a bad impact on environmental hygiene after being left unattended for a long time.

What is claimed is:

1. A glue mousetrap structure with a warning function, including:
a baseboard, with a support body arranged at a center thereof;
a carrier pivotally connected to the support body that may sway full-directionally and on two sides thereof is respectively disposed a snap fit structure;
a plurality of sensing members disposed between the baseboard and the carrier that are connected via a conducting wire to a control circuit that is provided with display lamps and is placed in a case body;
wherein the glue mousetrap board is first placed on the carrier; the stoppers on two sides of the carrier are then snap-fitted to the glue mousetrap board for the glue mousetrap structure to be placed on a ceiling or in an appropriate place; when a mouse steps on the glue mousetrap board, the carrier will sway under the weight and trigger the plurality of sensing members; the display lamps are thereby turned on to perform a warning function to remind a user to promptly dispose of the captured mouse a prevent mouse carcass from giving off stench and having a bad impact on environmental hygiene after being left unattended for a long time.

2. The glue mousetrap structure with a warning function of claim 1, wherein the support body includes a sphere disposed on the carrier and a socket disposed on the baseboard, so that after being embedded in the socket, the sphere may turn along socket and allow the carrier to sway full-directionally.

3. The glue mousetrap structure with a warning function of claim 1, wherein the snap fit structure is provided with a stopper; below the stopper is provided an axial part; a torsion spring is wound around the axial part to keep the stopper at a position parallel to a side edge of the carrier; on a side of the stopper is disposed an inclined block and a press button connected to the block, an axial part is provided at a bottom edge of the press button; a spring is wound around the axial part; when the stopper turns 90 degrees and passes the block, a stopping function is provided by the block and snap fit the glue mousetrap board to the glue mousetrap structure; and when the press button is pressed down, the block will be disengaged from the stopper and the stopper will return to its original position for the glue mousetrap board to be disposed of.

4. The glue mousetrap structure with a warning function of claim 1, wherein the plurality of sensing members are micro-switches or mercury switches.
